(19) United States
(12) Patent Application Publication
(10) Pub. No.: US 2006/0249022 A1
(43) Pub. Date: Nov. 9, 2006

(54) Gas supply and recovery for metal atomizer

(76) Inventors: Scot Eric Jaynes, Lockport, NY (US); Mark Kleis, Zionsville, IN (US); Jaak Van den Sype, Dobbs Ferry, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/536,390

(22) PCT Filed: Nov. 21, 2003
(86) PCT No.: PCT/US03/37413

§ 371 Date: Jul. 19, 2006

Related U.S. Application Data
(60) Provisional application No. 60/429,265, filed on Nov. 26, 2002.

(51) Int. Cl. B01D 46/00

(52) U.S. Cl. 95/273

(57) ABSTRACT

The invention uses helium and helium recovery purification equipment to remove impurities from the process enclosed equipment such as a melt chamber and atomization tower. An above atmosphere pressure argon/helium exchange can create the argon atmosphere needed for atomization.

### FIELD OF THE INVENTION

This invention relates to the use of a process gas such as argon where process equipment is first purified by helium and helium purification equipment.

### BACKGROUND OF THE INVENTION

It is known that processes based on argon can recycle and purify the argon used in the process. Purification equipment can include getters, PSA's, TSA's and cryogenic columns. However, separation of oxygen and nitrogen from argon with the above purification equipment can lead to excessive capital costs. It is also known that removal of oxygen and nitrogen from a helium gas has less capital cost. The separation of oxygen and nitrogen from helium occurs more readily due to the difference in physical characteristics of helium and other impurities.

As an example, it is known that atomized powders can be produced by injecting a gas stream around a molten metal stream through an atomization nozzle in a batch process. Generally the molten material is metal such as iron, steel, copper, nickel, aluminum, magnesium, lead, tin, titanium, cobalt, vanadium, tantalum and their alloys, or it may also be used to produce non-metallic powders such as employing oxides and/or ceramic materials as the molten stream. In many cases the use of high purity argon gas (e.g. at least 99.99 mol.%) is preferred.

It is also necessary to remove impurities from the melt chamber and atomization tower prior to the atomization. Such impurities include oxygen, nitrogen, water, carbon monoxide, carbon dioxide, metal and metal salts. Unfortunately, the separation of argon from oxygen and nitrogen is quite difficult and expensive. Aside from getters (i.e. chemical reactions), membranes and molecular sieves (e.g. found in PSA) treat oxygen and argon nearly the same. Therefore, argon purification, where the gas contains significant amounts of nitrogen and oxygen impurities involves regeneratable getters or cryogenic processes. Thus purification of argon in atomization processes is quite costly, whereas the purification of helium is much simpler and therefore less expensive.

More specifically, U.S. Pat. No. 4,629,407 discloses a metal atomization system with a gas recovery, purification and delivery system. The gas recovery system can handle noble gases and nitrogen. For noble gases the gas purification system uses a titanium getter to remove oxygen and nitrogen. For nitrogen the gas purification system uses other getters such as copper metal to remove oxygen. Both noble gases and nitrogen would use molecular sieves to remove water.

U.S. Pat. Nos. 4,838,912 and 6,123,909 each disclose argon recovery systems based on liquefaction and/or distillation of the argon.

### OBJECT OF THE INVENTION

It is therefore an object of the invention to provide a process and system allowing for efficient purification of a process enclosure with helium while intending to process with a different gas such as argon.

### SUMMARY OF THE INVENTION

The present invention uses helium and helium recovery equipment to purify a process enclosure before filling with the process gas. The process gas is used in a batch process where the process involves atomization, heat treating, chemical doping, metals processing or any other process where separation of impurities is difficult or expensive with the process gas. Thus, as a first step in the invention, a process enclosure contains impurities in an unacceptable concentration. An introduction of helium into the enclosure mixes helium with the impurities. Helium plus impurities then pass through purification equipment for the removal of impurities. Upon reaching an acceptable level of impurities in the process enclosure, as a next step, process gas replaces helium in the process enclosure.

One embodiment of the present invention uses helium and helium recovery equipment to purify a melt chamber and tower in a metal atomization process before filling with argon for atomization. Atomization is a batch process, where, after atomization occurs, the atomization chamber is opened to the atmosphere to be cleaned. This introduces air into the system. In accordance with the invention, therefore, the first step in the inventive process involves pulling a vacuum on the melt chamber and atomizer. The vacuum reduces the amount of air and other impurities. At the end of the vacuum step, helium is provided into the chamber and tower increasing the pressure therein to slightly above atmospheric pressure. The purity of the helium gas ranges from about 90 mol.% to 99.999 mol.% depending upon how the helium is introduced into the chamber. For example, when helium replaces air via a density exchange, the helium purity could be on the order of 90 mol.% after the exchange. On the other hand, if the helium is provided after the air has been removed via vacuum, the purity of the helium is on the order of 99.999 mol.% of provided directly from the purification system, or 99.995 mol.% if provided from, for example, a tube trailer. Compression equipment circulates the helium and impurities through a helium recovery system for purification. The helium purification system may use one or more of pressure swing adsorption and/or membranes to separate helium from air impurities to produce 99.999 mol.% helium. A preferred process is disclosed in commonly assigned WO 031011434 A1(Control System for Helium Recovery) and WO 031011431 A1 (Helium Recovery).

Following purification, helium is exchanged with, for example, argon. Argon enters the atomization system at a low point in the tower and as argon enters the atomization system, helium exits the system through a high point in the tower. In a preferred mode the argon/helium exchange achieves an atmosphere having greater than 90% argon. Helium remaining in the atomization system can remain as an argon impurity or be removed through additional processing. In high purity cases, the atomization atmosphere must contain less than 5 parts per million (ppm), preferably less than 2 ppm of oxygen, nitrogen, water, C0₂ and other impurities (excluding helium). During atomization, the same compression equipment that circulated helium now circulates argon. Additional compression may be utilized to increase the argon pressure to the required nozzle pressure (e.g. ranging from 100 to 1500 psi) for use in the atomization process.

More generally, the invention relates to a process for removing unacceptable impurities, for example, in air, from a process equipment comprising the steps of:

(a) removing air from the process equipment;

(b) introducing helium gas into said process equipment;

(c) circulating said helium gas throughout said process equipment;

(d) exchanging said helium with argon gas or other process gas; and

(e) completing a process with said process gas.

In one embodiment, the air is removed from said process equipment via vacuum prior to the introduction of helium gas.

In another embodiment said air replaced with said helium via density exchange.

In another embodiment said helium gas is provided from a purification system.

In another embodiment the purification system comprises one or more of a pressure swing adsorption system and a membrane system.

In another embodiment said purification system is connected to and integrated with said process equipment.

In another embodiment said helium gas is exchanged with said argon gas via a density exchange.

In another embodiment helium is introduced into said process equipment at subatmospheric conditions.

In another embodiment said process equipment includes one or more of a melt chamber and an atomization tower.

In another embodiment said process produces an atomized metal and contaminated argon gas.

In another embodiment said contaminated argon gas is disposed of.

In another embodiment said argon gas is passed through a purification system to remove one or more of said contaminants and atomized metal.

In another embodiment said contaminants are present in an amount of less than 2 ppm.

In another embodiment 90% or more of said helium gas is exchanged with argon.

In another embodiment the invention comprises a process system, for example, a metal atomization, comprising:

a) a process system, such as a metal atomization tower;

b) a source of helium gas;

c) a source of a process gas, such as argon gas;

d) means for exchanging the helium gas with a process gas such as argon gas and means for feeding the argon gas to the metal atomization tower. In this embodiment of the system, the source of helium gas is the helium purification system.

### BRIEF DESCRIPTION OF THE DRAWINGS

Other objects, features and advantages will occur to those skilled in the art from the following description of preferred embodiments and the accompanying drawing, in which:

FIG. 1 is a schematic diagram of a preferred embodiment of the invention.

### DETAILED DESCRIPTION OF THE INVENTION

The subject invention uses helium to purify process equipment (e.g. atomization tower and melt chamber) before the introduction of argon gas. Removal of air, methane and other impurities from helium occurs with membranes and molecular sieves. By using a standard PSA/membrane combination, gas purity in the process equipment can reach less than 5 ppm of the impurities mentioned above. A PSA/membrane helium recovery system can remove percent quantities of oxygen and nitrogen. After reaching the needed purity under a helium atmosphere, argon simply replaces helium in the process equipment.

The argon/helium exchange can take place by several known methods. A preferred method uses a density difference between helium and argon. In a density separation, argon is introduced in to the system at a low point and helium removal occurs at a system high point. If after the exchange the helium concentration in the argon is still too high then a membrane and/or PSA purification system can be used to reduce the helium concentration. Once the concentration of undesirable impurities (e.g. oxygen and nitrogen) are reduced to fall within acceptable levels (e.g. 2-5 ppm as noted above), the atomization process can begin.

Pressures within the process equipment and recovery equipment are kept above atmospheric pressure to eliminate leaks of air into the system. However, even at above atmospheric pressure oxygen and nitrogen can enter the process gas from metal or equipment off gassing. In the event levels of oxygen and nitrogen become too high, purification for argon may be accomplished via a slipstream (wherein a portion of the gas is removed , purified, and reintroduced) during compression to approximately 10 bar.

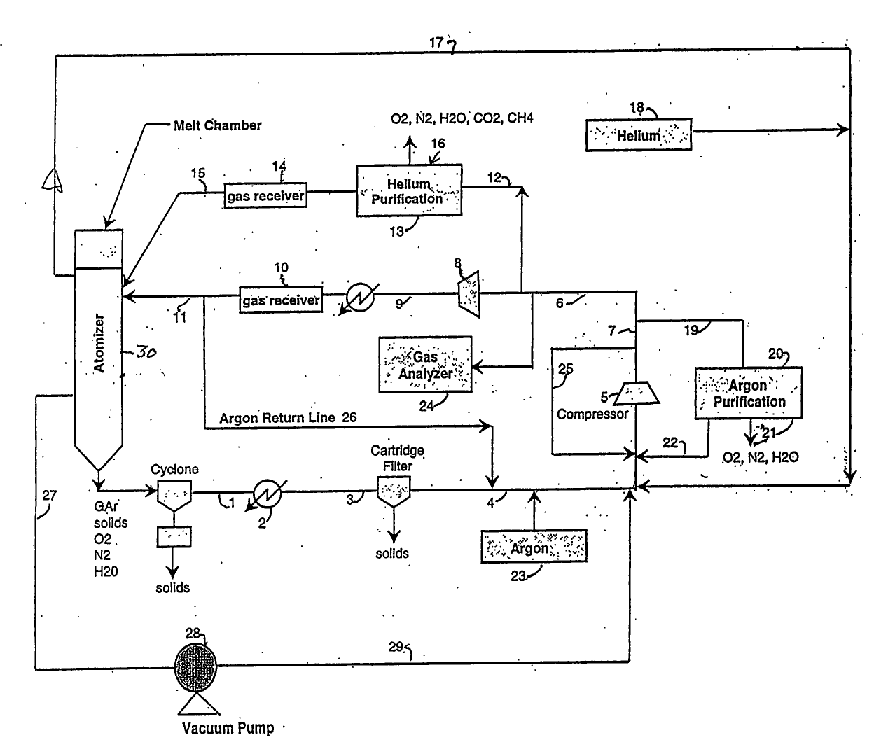

The subject invention is described in more detail with reference to FIG. 1. The invention starts with the introduction of helium (from either source 18 or from the purification process in PSA 16) into an atomizer 30, i.e. process equipment). Introduction of helium can occur as backfill after placing a vacuum on the process equipment (to remove air) via line 27 using, for example, vacuum pump 28. Air is then fed to the argon purification system via line 29 and compressor 5.

Helium can also be introduced via a density exchange between air and helium. For the density exchange, helium is introduced at a high point in the equipment while air is removed at a low point (e.g. line 27). Following the helium/air exchange a helium concentration of 90% or more is expected. Once the helium occupies the process equipment then compressor 5 starts and moves gas through the PSA 13, with impurities exiting through line 16. Pure gas leaves the PSA and enters the process equipment through duct 15. Thus, gas flows in a circular pattern through the process equipment and purification equipment. Compressor 5 continues to move gas in a circular pattern until analyzer 24 indicates that the impurities levels (e.g. oxygen and/or nitrogen) are within specifications. Compressor 5 begins to recycle through duct 25 once the impurity levels are within specifications.

The next step involves the replacement of helium with argon. Through the use of another density exchange, argon replaces helium. Argon 23 enters duct 4. Helium leaves the process chambers through a high point at duct 17. Duct 17 returns helium to compressor 5 and to gas receiver 14. The exchange of argon for helium continues until the argon reaches the desired concentration.

After completion of the helium/argon exchange, compressor 5 increases the pressure of argon in duct 6 from 10 to 13 bar. The pressurized argon flows through duct 7 to compressor 8. Compressor 8 pressurizes the argon to the nozzle pressure (<150 bar). Argon at the nozzle pressure fills gas receiver 10. Additional argon to fill gas receiver 10 comes from argon make up at 23. Gas receiver 10 is sized to remove pulsing from compressor 8 via duct 9. Thus, the invention has an economic advantage over the prior art with a smaller high pressure receiver. The invention circulates gas rapidly and does not require a large inventory of high pressure gas.

Operation and control of the argon loading process is achieved through compressor turn down and other valving. To keep duct 4 from reaching a negative gage pressure, compressor 5 reduces capacity through turn down capabilities and argon return gas from duct 11 to duct 4 through duct 26. Maintaining a positive gage pressure in duct 4 is important since a negative gage pressure introduces air into the system. Even PPM levels of air can take the argon out of specifications. Similar control occurs during the atomization process to ensure that excess impurities do not enter the system.

During atomization, atomization gas and solids leave the atomization tower. Solids fall out of the gas stream as it passes through a cyclone 1 and cartridge filter 2 via duct 3. Solids free gas then enters compressor 5. Analyzer 24 continues to monitor the gas stream for compliance to specifications.

If gas specifications are not within specifications then a flow control valve in duct 19 opens. The control valve opens with respect to the amount of impurities measured by analyzer 24. The sizing of compressor 5 allows for up to 50% of the nozzle flow to enter duct 19. Thus, if the atomizing nozzle flow after duct 11 is 1000 scfm then compressor 5 must process 1500 scfm when the control valve is full open. By controlling valve in duct 19 based on impurities, power is minimized at compressor 5 and utilities are minimized for operating argon purification 20. After impure argon gas passes through duct 19, it enters into argon purification 20.

Argon purification 20 can include a thermal swing adsorption system (TSA) to remove C0₂ and water, catalytic oxidation with hydrogen to remove oxygen, or getters to remove oxygen and nitrogen. In the most preferred case, argon purification could involve cryogenic adsorption. Cryogenic adsorption could remove oxygen and nitrogen from argon. The bulk of impurities are removed with the helium purification system. Thus, impurities entering the system from metal off gassing should be very low. Argon purification 20 is much smaller than that in the prior art. Following purification, pure process gas (e.g. 99.999 mol.%) returns to compressor 5 through duct 22 for compression, while impurities exit via duct 21.

Following the helium/argon exchange, helium is present as an impurity of several percent (e.g. between 1-10 mol.%). If the helium concentration in the argon is too high then part of argon purification process 20 could be used to remove helium from argon. If the helium concentration in the argon must be lower before the start of atomization then a separate duct and valve would circulate gas from argon purification 20 to atomizer instead of flowing through duct 22. A membrane system would provide the most preferred method for removing helium. Using a membrane can remove helium into the ppm level. Other methods for removing helium from the argon gas could involve PSA or cryogenic separation.

Using a mix of argon and helium as the atomizing gas may provide benefits. Thus instead of completing a helium/argon exchange to >90% argon the process would stop with a different mix. For instance, if the atomizer desired a 50/50 mix of helium and argon then argon purification system would work the same as described above.

Instead of argon purification in loop around compressor 5, argon purification could in duct 6. This would reduce the size of compressor 5. In the case of cryogenic adsorption, compressor 5 would create a pressure in duct 6 less than the saturation pressure for the argon at the adsorption temperature. Treating the entire process gas stream would increase refrigeration cost over the preferred method.

Instead of argon purification 20, argon make up at 23 could inlet an amount of fresh argon to dilute the impurities. A vent after the atomizer would discharge the excess gas.

Specific features of the invention are shown in the drawing for convenience only, as each feature may be combined with other features in accordance with the invention. Alternative embodiments will be recognized by those skilled in-the art and are intended to be included within the scope of the claims.

What is claimed is:

1. A process for removing undesired impurities from a gas in an process enclosed equipment comprising the steps of:
(a) removing any air from the process enclosed equipment;
(b) introducing helium gas into said process enclosed equipment;
(c) circulating said helium gas throughout said process enclosed equipment to remove impurities;
(d) exchanging said helium with a process gas; and
(e) initiating a process with said process gas.

2. The process of claim 1, wherein said process gas is selected from the group consisting of argon, nitrogen, endo gas and mixtures thereof.

3. The process of claim 1, wherein said air is removed from said process equipment via vacuum prior to the introduction of helium gas.

4. The process of claim 1, wherein said air is replaced with said helium via density exchange.

5. The process of claim 1, wherein said helium gas is provided from at least one purification system, and wherein said purification system is connected to and integrated with said process equipment.

6. The process of claim 1, wherein said process equipment includes one or more of a melt chamber and an atomization tower, and wherein said process produces an atomized metal and contaminated argon gas.

7. The process of claim 1 wherein said process equipment is selected from the group consisting of chemical vapor deposition equipment, cold spray forming equipment, thermal spray equipment, metal casting equipment, ceramic processing equipment, plasma arc equipment and vacuum equipment.

8. The process of claim 6, wherein said argon gas is passed through a purification system to remove contaminants.

9. A process equipment comprising:
(a) an enclosed process equipment;
(b) a source of helium gas;
(c) a source of a processing gas; and
(d) means for exchanging the helium gas with the processing gas in the enclosed environment.

10. The process enclose equipment of claim 9 wherein said process equipment is selected from the group consisting of metal atomization tower, chemical vapor deposition, cold spray forming, thermal spray, metal casting, ceramic processing, plasma arc and vacuum arc.
